(19) United States
(12) Patent Application Publication
(10) Pub. No.: US 2003/0072836 A1
(43) Pub. Date: Apr. 17, 2003

(54) Clay bead roller and method

(76) Inventor: Janet Sue Lee, Woodson, IL (US)

Correspondence Address: Donald W. Meeker, Patent Agent, #512, 750 La Playa, San Francisco, CA, 94121, US

(21) Appl. No.: 10/269,132

(22) Filed: Oct. 12, 2001

(51) Int. Cl. B29C 67/02

(52) U.S. Cl. 425/332; 264/40.1; 264/117; 425/333

(57) ABSTRACT

An elongated top and an elongated base each having mated roller components in the shape of mating inverted elongated surfaces which form a rolling bead roller chamber therebetween. A measured amount of clay or similar material is placed in the bead roller chamber and rolled into a uniformly shaped and sized bead by sliding the top back and forth relative to the base in the elongated direction. The bead roller is injection molded of polycarbonate to be non-reactive with polymer clay, and it is transparent to enable the observation of the bead rolling process. Multiple roller components may be built into a base with mating multiple roller components built into a top with a handle or individual top roller components. Semi-circular roller components form round beads, circular arc shaped roller components form oval football-shaped beads, and V-shaped roller components form double cone shaped beads.

### BACKGROUND OF THE INVENTION

1. Field of the Invention

The present invention relates to the art of forming shapes in plastic media and in particular to a bead roller and method for forming clay and other plastic media beads of various uniform and consistent shapes.

2. Description of the Prior Art

A common sculpting medium is clay, which is of mineral origin and comes either in water-based or oil-based form. Water-based clays are typically used by the artist or craftsperson to fashion pottery or small figurines and require a high heat firing process which can damage the clay.

One class of sculpting medium is polymer based. One such formulation incorporates polyvinyl chloride as the filler. Formation of a permanent sculpture usually requires a curing process at a much lower elevated temperature than the water based clay. The polymer clay comes in a wide variety of greatly diverse bright colors which are usually combined in decorative patterns in the clay enabling the polymer clay to be formed into attractive colorful items, such as beads for jewelry or for use in accessory items such as purses. Some materials react chemically with polymer clay so that the clay marks the materials.

Forming polymer clay beads has become a very popular craft or art form. Typically such beads are formed by hand or sometimes by rolling with a makeshift device such as cut plastic (PVC) pipe found only in round shapes. There was always a lack of uniformity and lack of precision forming in the beads produced by hand forming. Some prior art attempts have been made in forming other plastic materials, such as dough, into shapes, but a system and method using mass producible materials for forming polymer beads in consistent and accurate shapes and sizes has been lacking.

U.S. Pat. No. 6,224,365, issued May 1, 2001 to Robert Ou-Young, provides an apparatus including two symmetrical slide members moved relative each other for shaping a cylindrical body into a plurality of spherical bodies, wherein the slide members each have two vertical sidewalls, and a plurality of U-grooves and partition flanges alternatively arranged in parallel between the vertical sidewalls, the U-grooves each having two distal ends and a depth gradually increased from one distal end to the other, the partition flanges each having two distal ends and a thickness gradually increased from one distal end to the other, the vertical sidewalls each having two distal ends and an inner side vertically curved inwards, the inner side having a vertical depth gradually increased from one distal end to the other.

U.S. Pat. No. 432,127, issued Jul. 15, 1890 to Samuel C. Dyke, shows an improvement to devices for performing one step in the process of manufacturing playing marbles from plastic clay by accurately rounding or rendering slugs of clay spherical.

U.S. Pat. No. 33,136, issued Aug. 27, 1861 to Adam Exton, describes a machine for molding dough into crackers, biscuits, etc., using fluted or grooved plates for molding the dough.

U.S. Pat. No. 2,231,556, issued Feb. 11, 1941 to Leonard G. Arpin, relates a method to manufacture spherical articles such as beads and marbles of all types, especially made from plastic material formed into rods, which is then maintained between grinding elements shaped in semi-circular grooves so that a ball is formed for each groove of the grinder element.

U.S. Pat. No. 2,241,365, issued May 6, 1941 to Maximilian C. Meyer, puts forth novel method of forming ornamental objects from plastics containing faceted light reflecting particles.

What is needed is mass produced equipment as part of a system and method for supplying all of the bead making enthusiasts with a consistent and uniform system and method for forming polymer beads quickly and easily in any quantity desired.

### SUMMARY OF THE INVENTION

An object of the present invention is to provide a system and method for rolling clay beads which provides uniformity and consistency of each shape and size of beads for a variety of different shapes and sizes of beads by using measured amounts of polymer clay or other similar material in rolling equipment having components configured in different sizes and shapes which consistently produce uniformly shaped beads.

Another object of the present invention is to provide a system for rolling polymer or other clay type beads and with components which can be mass produced by injection molding techniques to supply a widespread demand.

One more object of the present invention is to provide bead rolling equipment which is formed of transparent material to enable the user to view the bead as it is being rolled to insure that the bead will be rolled exactly as desired and it will be apparent when the bead is fully rolled.

An additional object of the present invention is to provide bead rolling equipment which is fabricated of a material, polycarbonate, which is impervious to chemical reaction with polymer clay to insure that the equipment will last indefinitely and can be used an unlimited number of times and maintain a smooth surface for proper rolling of the beads. This material is very durable and works well with any type of clay or other similar material, including Crayola Model Magic Modeling Compound, Creative Paper Clay, Aleene's Recipe Bread Dough, and La Doll Air Dry Clay.

A further object of the present invention is to provide bead rolling equipment which has a number of compartments for simultaneously rolling a number of beads at the same time.

A contributory object of the present invention is to provide measuring means for cutting a precise amount of clay for precision in sizing the beads.

In brief, the present invention provides a system for bead rolling with rulers and cutters for measuring and cutting a precise quantity of polymer or other type of clay or similar material to put into the rollers. The rollers each have two mating elongated components of a similar cross-sectional shape which are moved back and forth along the length of the rollers with the measured amount of polymer clay between them to create a bead of an exact and uniform shape based on the cross-sectional shape.

Half round roller components produce circular beads. V-shaped roller components produce double-cone shaped beads. Partial circular arc shaped roller components produce oval or football-shaped beads. Roller components having long central parallel flat surfaces with outwardly angled ends produce cylindrical beads with cone-shaped ends. Many other shapes could also be used within the scope of the invention.

Two roller components may be formed with one fitting into a track with side edges on the other to insure uniform sliding of one relative to the other. Various sizes of top roller components may be used inside a base roller component of equal or larger size and having the same cross-sectional shape.

A multi-unit base may have several differently sized roller components of the same cross-sectional shape or of different cross-sectional shapes. The base may be used with single top roller components of various sizes or a multi-unit top with roller components the same sizes as the base, both the single and multi-unit top having matching cross-sectional shapes to the base components.

Preferably the rollers are injection molded of polycarbonate material which is resistant to chemical reaction with the polymer clay and very durable to endure prolonged and repeated use. The bead rollers are transparent so that the rolling of the clay to form a bead can be observed to insure quality and to see when the bead is fully rolled.

An advantage of the present invention is to provide mass produced bead roller systems to meet a growing demand.

Another advantage of the present invention is to provide uniformity and consistency of shape and size of clay beads.

An additional advantage of the present invention is to provide bead rollers which produce multiple clay beads at the same time.

One more advantage of the present invention is to provide a bead roller which enables the user to watch the bead being rolled.

Yet another advantage of the present invention is to provide bead rollers that will produce beads in a variety of sizes and shapes.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a multi-roller-component base and multi-roller-component top having mating half circle cross-section roller components of different sizes with a single handle on the top and tracks along the side edges of the base for sliding the sides of the in the tracks;

FIG. 2 is an end elevational view of a multi- roller-component base having half circular cross-section roller components of different sizes with each roller component having side tracks and a single mating circular cross-section individual top roller component sliding in each of the tracks as well as other single partial circular arc shaped top roller components used with each base roller component having a similar arc radius and also showing the beads produced by each combination;

FIG. 3 is a transverse cross-sectional view taken through a bead roller of the present invention having a single V-shaped roller component in the base with side tracks running longitudinally and a mating single inverted V-shaped roller component with a handle in the top riding in the tracks and showing the edge of alternate single top inverted V-shaped roller components of various sizes, such as those of FIGS. 4A and 4B, riding in the base V-shaped roller component, all having the same V angle, and further showing the double conical pointed end beads produced by each of the roller component top and bottom V-shaped pairs;

FIG. 4A is an end elevational view of a multiple sized V-shaped roller component in two elongated pieces having mating elongated angled surfaces of different widths which form two different sized V-shaped roller components, one on top and a different one on the bottom when connected together as in FIG. 4A with the piece having protruding pegs on the right and the piece having receiving openings on the left;

FIG. 4B is an end elevational view of the multiple sized V-shaped roller component of FIG. 4A having two different sized V-shaped roller components dissimilar to those of FIG. 4A due to having the piece having protruding pegs on the left and the piece having receiving openings on the right to match differently sized angled surfaces;

FIG. 5 is an end elevational view taken through a bead roller of the present invention having a single partial circle arc-shaped roller component in the base and a mating single partial circle arc-shaped roller component with a handle on the top riding in the lower bead roller component and showing the oval football-shaped beads produced by the mating roller components;

FIG. 6 is a perspective view showing a bead roller of the present invention with two mating roller components having in cross-section long central parallel flat surfaces with outwardly angled ends and showing a cylindrical bead with cone-shaped ends produced by the mating roller components;

FIG. 7 is a perspective view showing the bead roller of the present invention having a base with a V-shaped roller component and a semicircular shaped roller component on one surface and a partial circle arc roller component on an opposite side with mating single top roller components aligned with the base components for rolling.

### BEST MODE FOR CARRYING OUT THE INVENTION

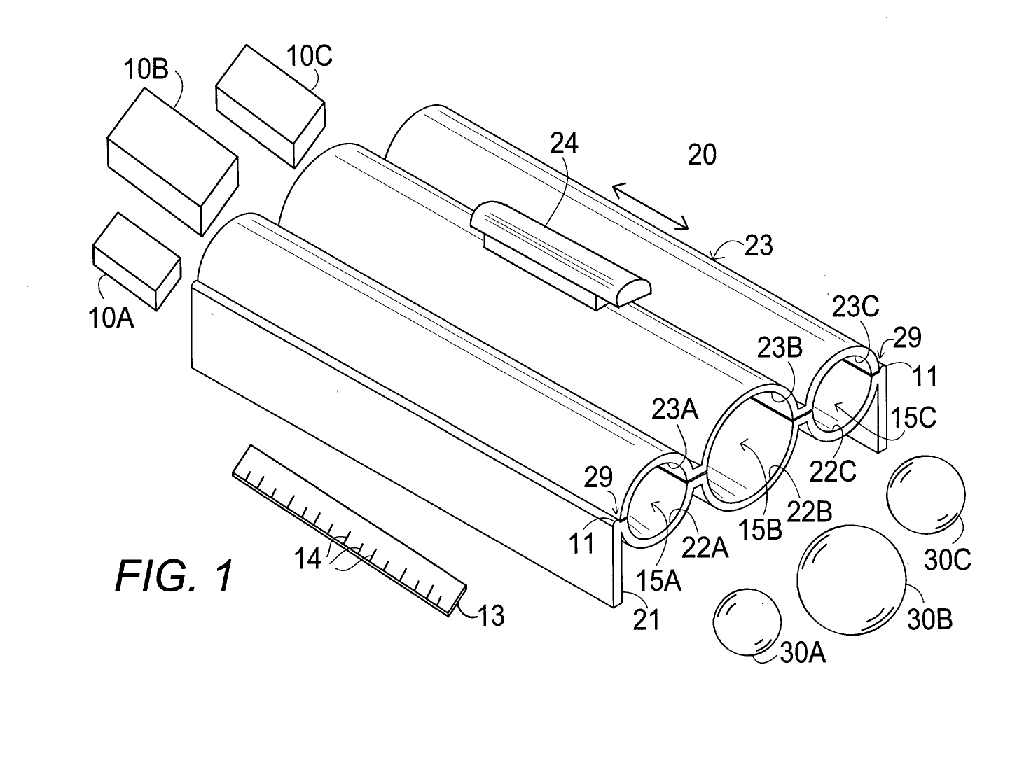

In FIGS. 1-3 and 5-7, a bead roller device 20A-E for rolling uniformly shaped and sized beads of clay polymer and other similar material comprises an elongated tool having at least one pair of roller components having elongated matched surfaces, such as matched top roller components 23A-C and bottom roller components 22A-C respectively of FIG. 1 capable of coming into mutual contact to form a bead roller chamber, such as a cylindrical bead roller chamber 15A-C, between the matched surfaces. The bead roller chamber is capable of receiving a measured amount of polymer or other type of clay 10A-C or similar material therein, and the pair of roller components capable of relative back and forth motion in the direction of elongation, as shown by the double ended arrow of FIG. 1, to roll the clay between the elongated matched surfaces to form a bead, such as a spherical bead 30A-C of FIG. 1, having a smooth shape with a circular transverse cross-section and a shape and size uniformly matched to other beads rolled therein.

The measured amount of clay 10A-C can be measured with a measuring tool, such as a ruler 13 with marked length measurements 14 and the clay, of uniform cross-section as packaged, cut into appropriately sized amounts for each bead roller chamber 15A-C.

The bead roller devices are formed by a mass production process, such as injection molding of a material, such as polycarbonate, resistant to chemical interaction with polymer clay. The bead roller devices are formed of transparent material so the bead may be observed during the rolling process to insure quality and know when the rolling is completed.

The bead roller device comprises a base 21 and 21A-E having a bottom surface capable of resting in a stationary position on an external surface and a top 23 and 28A-J having a means for gripping, such as a handle 24, 24A and 24B so that the top is capable of being gripped by hand and moved back and forth relative to the base in the direction of elongation.

In FIGS. 1, 2, and 7 the base 21, 21A, and 21E comprises three roller components secured thereto. In FIG. 1, the bottom roller components 22A, 22B, and 22C are variously sized elongated surfaces of semicircular cross-section. The top 23 has three top roller components 23A-C built in of variously sized elongated surfaces of semicircular cross-section to mate with the bottom roller components 22A-C and form a cylindrical roller chamber 15A-C. The handle 24 is gripped for moving the top 23 relative to the base 21 back and forth in the direction of elongation, as shown by the double arrow, with the side edges of the top sliding in tracks 29 formed by elevated ridges 11 along the top side edges of the base 21, to roll the measured amounts of clay 10A-C into uniformly shaped spherical beads 30A-C of three different sizes.

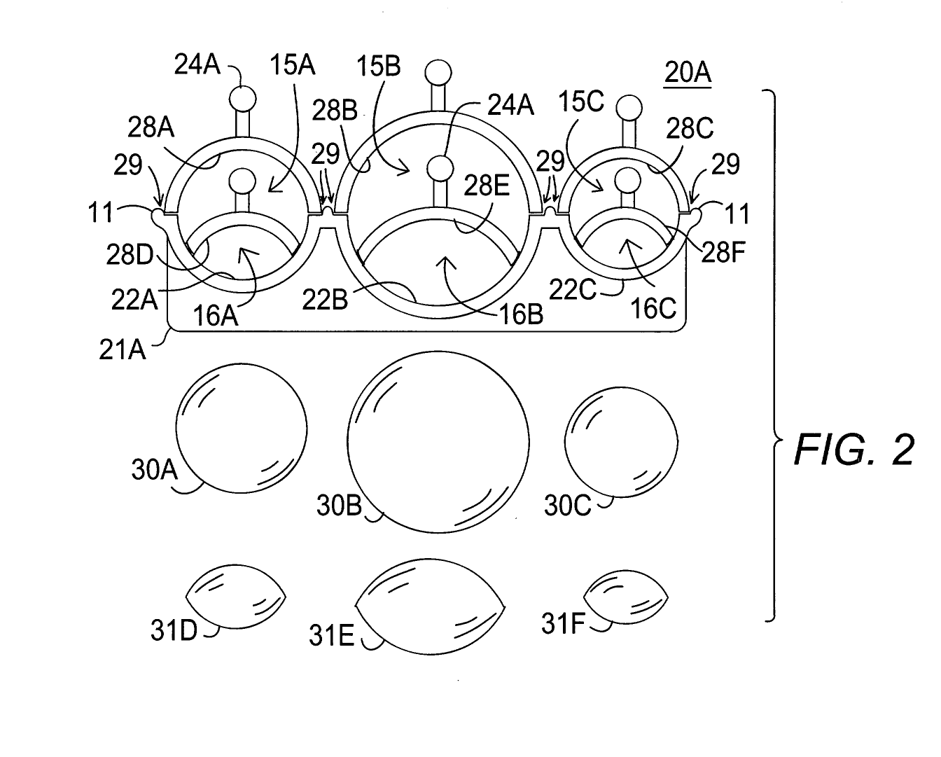

In FIG. 2, a base 21A has three differently sized semicircular bottom roller components 22A, 22B, and 22C with top tracks 29 between each defined by protruding ridges 11 above adjacent flat surfaces. In this embodiment, three separate semicircular top roller components 28A, 28B, and 28C riding in the three tracks, each with its own handle 24A to move back and forth relative to the mating bottom roller components 22A-C. The semicircular mating roller elements form cylindrical bead roller chambers 15A-C to produce spherical beads 30A-C of different sizes.

Also shown in FIG. 2 are three alternate separate top roller components 28D, 28E, and 28F each having an arc of a circle with a mating diameter to the bottom semicircular roller components, so that each of the top roller components 28D-F may be placed within each of the mating diameter bottom roller components 22A-C to create elongated oval bead roller chambers 16A, 16B, and 16C to produce oval football-shaped beads 31D, 31E, and 31F.

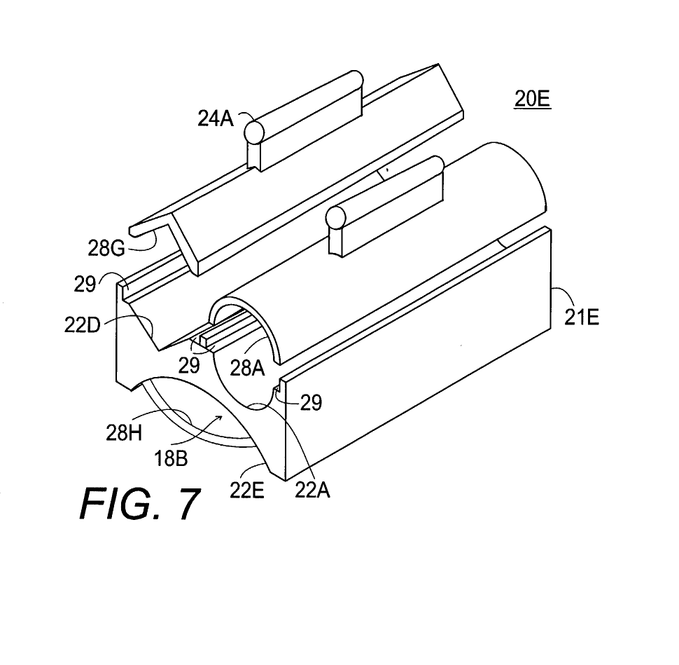

In FIG. 7, a base 21E has multiple roller components of different shapes, including an elongated surface V-shaped in cross-section forming a V-shaped roller component 22D with a mating single inverted V-shaped top roller component 28G, an elongated surface semicircular in cross-section forming a semicircular roller component 22A with a mating top semicircular roller component 28A, both on one side and, on the opposite side, an elongated surface having an arc of a circle in cross-section forming an arc-shaped roller component 22E with a mating arc shaped single roller component 28H.

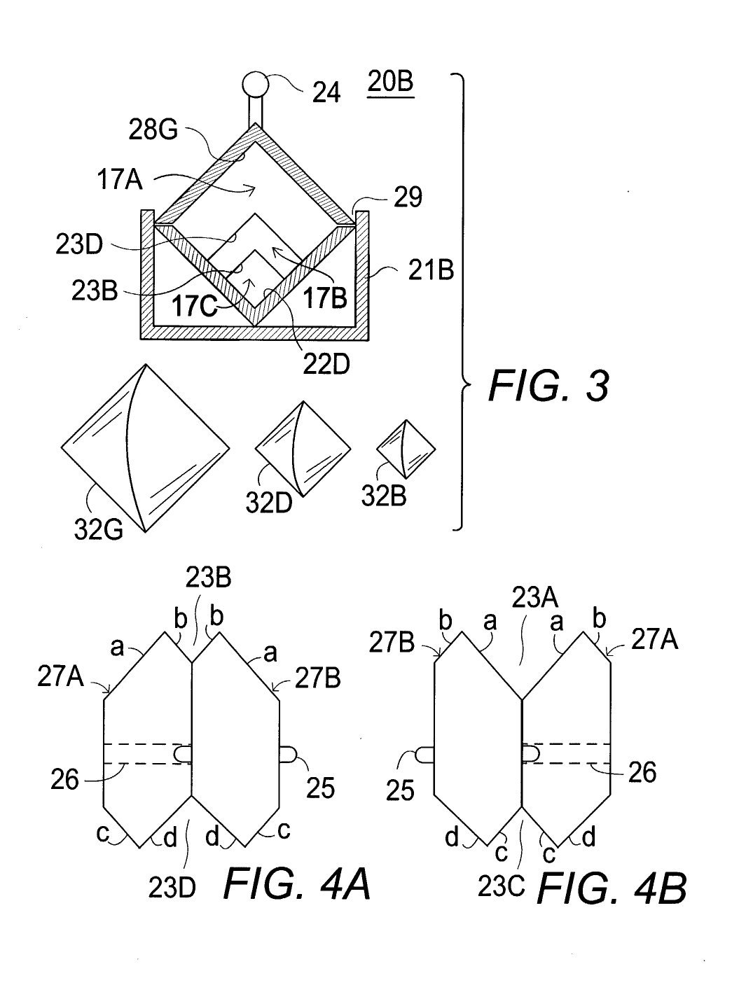

In FIGS. 3-6 each base 21B, 21C, and 21D has a single bottom roller component which can be used with single top roller components. In FIG. 3 the base 21B has a built-in elongated surface V-shaped in cross-section forming a V-shaped roller component 22D with a mating single inverted V-shaped top roller component 28G sliding in side tracks 29 to form double conical shaped beads 32G.

In FIGS. 4A and 4B, an elongated element having two pieces, a first multisided piece 27A and a second multisided piece 27B of mirror image in cross-section interlocked by protruding knobs 25 from the second piece 27B engaging an opening 26 through the first piece 27A to enable attachment on one side with the first piece 27A on the left, as in FIG. 4A, or attachment on the other side with the first piece 27A on the right, is in FIG. 4B. Each piece has elongated angled surfaces of four different widths with two surfaces a and b on the top and two surfaces c and d on the bottom. In FIG. 4A, when connected together the two pieces, 27A on the left and 27B on the right, form a multiple sized V-shaped roller component, which form two different sized V-shaped roller components 23B and 23D, one 23B with sides b-b on top and a different one 23D with sides d-d on the bottom. In FIG. 4B, when connected together the two pieces, with 27B on the left and 27A on the right, form a multiple sized V-shaped roller component, which form two different sized V-shaped roller components 23A and 23C, one 23A with sides a-a on top and a different one 23C with sides c-c on the bottom. The multi-sized V-shaped roller component may be used with a base 21B having a V-shaped bottom roller component 22D, such as in FIG. 3 which shows two inverted V-shaped lines 23D and 23B representing the V-shaped roller components of the multi-sized V-shaped roller component of FIGS. 4A and 4B to produce double cone shaped beads 32D and 32B.

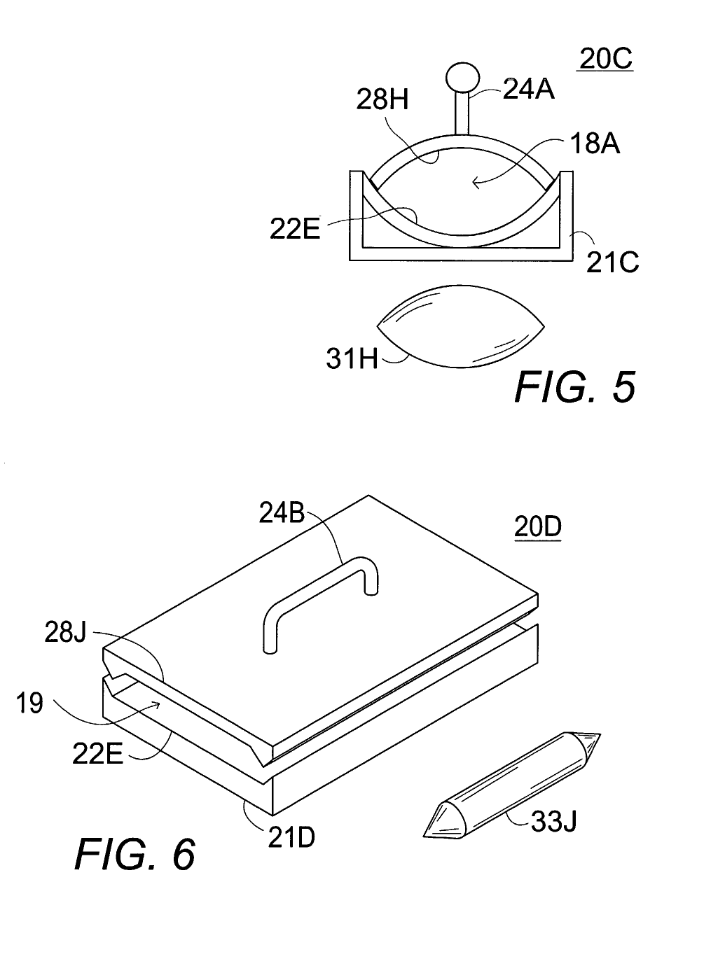

In FIG. 5, a bead roller has a single partial circle arc-shaped roller component 22E in the base 21C and a mating single partial circle arc-shaped roller component 28H with a handle 24A on the top riding in the lower bead roller component to produce an oval football-shaped bead 31H.

In FIG. 6, a bead roller has a base 21D with a single bottom roller component 22E and a mating single top roller component 28 with a handle 24B wherein the two mating roller components have elongated surfaces shaped in cross-section with long central parallel flat surfaces with outwardly angled ends forming a bead roller chamber 19 therebetween which produces a cylindrical bead with cone-shaped ends 33J.

In practice a bead roller method for rolling uniformly shaped and sized beads of clay polymer and other similar material comprises: a first step of measuring the clay with a measuring tool and placing a measured amount of clay in an elongated tool comprising at least one pair of roller components having elongated matched surfaces capable of coming into mutual contact to form a bead roller chamber between the matched surfaces, the measured amount of clay being placed in the bead roller chamber, and a second step of sliding the pair of roller components in a relative motion in the direction of elongation to roll the clay between the elongated matched surfaces to form a bead having a smooth shape with a circular transverse cross-section and a shape and size uniformly matched to other beads rolled therein. The elongated tool is formed of transparent material which allows the user to observe the bead being formed during the rolling process.

The elongated tool has a base with a bottom surface capable of resting in a stationary position on an external surface and a top having a means for gripping, so the top is gripped by hand and moved back and forth relative to the base in the direction of elongation as shown by the double arrow of FIG. 1.

When the base comprises at least two roller components, preferably three as in FIGS. 1, 2, and 7 or possibly more, secured thereto and the top comprises the same number of roller components mating with the roller components of the base, measured amounts of clay are placed in each bead roller chamber to enable rolling multiple beads at one time. When the roller components are of different sizes, different sizes of beads can be rolled at one time, as in FIGS. 1 and 2. When the roller components are of different shapes, differently shaped beads can be rolled at one time is in FIG. 7.

It is understood that the preceding description is given merely by way of illustration and not in limitation of the invention and that various modifications may be made thereto without departing from the spirit of the invention as claimed.

What is claimed is:

1. A bead roller device for rolling uniformly shaped and sized beads of clay and other similar material, the device comprising:
an elongated tool comprising at least one pair of roller components having elongated matched surfaces capable of coming into mutual contact to form a bead roller chamber between the matched surfaces, the bead roller chamber capable of receiving a measured amount of clay therein, and the pair of roller components capable of relative motion in the direction of elongation to roll the clay between the elongated matched surfaces to form a bead having a smooth shape with a circular transverse cross-section and a shape and size uniformly matched to other beads rolled therein;
the roller components being formed by a mass production process of a material resistant to chemical interaction with clay.

2. The device of claim 1 wherein the elongated tool is formed of transparent material so the bead may be observed during the rolling process.

3. The device of claim 1 wherein the elongated tool comprises a base having a bottom surface capable of resting in a stationary position on an external surface and a top having a means for gripping so that the top is capable of being gripped by hand and moved back and forth relative to the base in the direction of elongation.

4. The device of claim 3 wherein the base comprises at least two roller components secured thereto.

5. The device of claim 4 wherein the at least two roller components are of different sizes.

6. The device of claim 4 wherein the at least two roller components are of different shapes.

7. The device of claim 4 wherein the top comprises at least two roller components mating with the at least two roller components of the base.

8. The device of claim 1 further comprising an elongated element having two multisided pieces, of mirror image in cross-section, interlocked by a connecting means enabling the first piece to be attachable on the left side of the second piece and alternately on the right side, each piece comprising elongated angled surfaces of four different widths with two surfaces on the top and two surfaces on the bottom so that when connected together the two pieces form a multiple sized V-shaped roller component, with V-shaped roller components of four different sizes capable of being used with another V-shaped roller for rolling four differently sized beads.

9. The device of claim 1 further comprising a measuring tool for measuring the measured amount of clay.

10. A bead roller method for rolling uniformly shaped and sized beads of clay and other similar material, the method comprising:
a first step of placing a measured amount of clay in an elongated tool comprising at least one pair of roller components having elongated matched surfaces capable of coming into mutual contact to form a bead roller chamber between the matched surfaces, the roller components being formed by a mass production process of a material resistant to chemical interaction with clay, the measured amount of polymer clay being placed in the bead roller chamber;
a second step of sliding the pair of roller components in a relative motion in the direction of elongation to roll the clay between the elongated matched surfaces to form a bead having a smooth shape with a circular transverse cross-section and a shape and size uniformly matched to other beads rolled therein.

11. The method of claim 10 wherein the elongated tool is formed of transparent material and the second step further comprises observing the bead during the rolling process.

12. The method of claim 10 wherein the elongated tool further comprises a base having a bottom surface capable of resting in a stationary position on an external surface and a top having a means for gripping, and the second step comprises gripping the top by hand and moving it back and forth relative to the base in the direction of elongation.

13. The method of claim 12 wherein the base comprises at least two roller components secured thereto and the top comprises at least two roller components mating with the at least two roller components of the base, and the method comprises placing at least two measured amounts of clay in the bead roller chamber and forming at least two beads at one time.

14. The method of claim 13 wherein the at least two roller components are of different sizes, and the method comprises forming at least two different sizes of beads at one time.

15. The method of claim 13 wherein the at least two roller components are of different shapes, and the method comprises forming at least two differently shaped beads at one time.

16. The method of claim 13 wherein the top comprises at least two separate roller components each with its own handle mating with the at least two roller components of the base.

17. The method of claim 10 further comprising rolling any of four differently sized beads using a V-shaped roller component with an elongated element having two multisided pieces, of mirror image in cross-section, interlocked by a connecting means enabling the first piece to be attachable on the left side of the second piece and alternately on the right side, each piece comprising elongated angled surfaces of four different widths with two surfaces on the top and two surfaces on the bottom so that when connected together the two pieces form a multiple sized V-shaped roller component, with V-shaped roller components of four different sizes.

18. The method of claim 10 further comprising a measuring tool for measuring the measured amount of polymer clay, and the first step further comprises measuring the measured amount of clay with the measuring tool.
